(19) United States
(12) Patent Application Publication
(10) Pub. No.: US 2022/0398612 A1
(43) Pub. Date: Dec. 15, 2022

(54) INFORMATION PROCESSING APPARATUS, INFORMATION PROCESSING SYSTEM, AND PROGRAM

(71) Applicant: Insight science Inc., Tokyo (JP)

(72) Inventor: Kazuya MURAKAMI, Tokyo (JP)

(21) Appl. No.: 17/806,714

(22) Filed: Jun. 13, 2022

(30) Foreign Application Priority Data
Jun. 14, 2021 (JP) 2021-098550

(51) Int. Cl. G06Q 30/02

(52) U.S. Cl. CPC G06Q 30/0204

(57) ABSTRACT

An information processing apparatus includes a distribution pattern generating section, a behavior pattern acquiring section, a clustering section, and a pattern distributing section. The distribution pattern generating section generates distribution patterns of a website. The behavior pattern acquiring section acquires user behavior patterns in the website through the website. The clustering section clusters two or more users as a group of users, the two or more users behaving in specific behavior patterns correlated with a target behavior pattern intended by a provider of the website among the behavior patterns acquired by the behavior pattern acquiring section, the specific behavior patterns being similar to each other. The pattern distributing section distributes a distribution pattern in which a reaction rate of the group of users clustered by the clustering section is relatively high among the distribution patterns generated by the distribution pattern generating section to a user terminal used by a user corresponding to the group of users.

### BACKGROUND OF THE INVENTION

### 1. Technical Field

The present invention relates to an information processing apparatus, an information processing system, and a program related to distribution of a distribution pattern in a web page or the like.

### 2. Description of the Related Art

In recent years, various websites can be viewed through the Internet or the like. Usually, one website includes a large number of web pages. Each web page is described in HyperText Markup Language (HTML), and includes elements such as text information, image files such as photographs and illustrations, moving images, audio, Cascading Style Sheets (CSS) prepared to lay out and decorate each page, and hyperlinks for opening other related pages.

A website includes a so-called home page (top page) or a landing page (including landing pages in both a broad and narrow sense, hereinafter referred to as “LP”) that is usually viewed first by a user who visits the website.

In order to view a target website, a user inputs a predetermined keyword into a search window of an existing search engine (e.g., Google (registered trademark) or Yahoo (registered trademark)), and clicks (presses) a “search” button using a mouse or the like. Thereafter, a desired website is displayed according to the search keyword.

### SUMMARY OF THE INVENTION

In recent years, a huge number of websites have become viewable through the Internet. To search for a target website using the search engine described above, a user inputs a predetermined keyword in the search window of the search engine and clicks the “search” button. As a result, a large number of websites including the search keyword are listed in order according to number of views or popularity as search results. In many cases, the user must rely on this simple display of listed websites to find the desired website, possibly in combination with a narrowed search using additional keywords. As a result, while the user spends more time, servers that provide websites are heavily burdened. In addition, it is possible that the target website will not be found even by a narrowed search with additional keywords.

In order to solve such a problem, JP 2016-503212 A discloses an invention related to a computer that obtains product information details associated with current product information content accessed by a user, automatically organizes the content of a landing page using the product information details, and returns new content to a browser to generate a landing page. According to the computer described in JP 2016-503212 A, the user does not need to perform an additional search for the same product, and receives related detailed product information returned from a server in response to an access request. This can reduce the amount of time the user spends searching for a product and reduce the burden of traffic on servers.

According to the technique of JP 2016-503212 A, it is possible to obtain detailed information about a target product in response to an access request from the user. However, even if detailed information about the target product is obtained, there is no confirmation that the user purchases the product through the displayed web page.

However, a technique for distributing a web page optimized according to an access log of a user to a specific website or an attribute of the user has appeared in recent years. For example, JP 6758582 B1 discloses a technique of specifying the country from which a user accesses a web page based on a global IP address and providing content (a web page) suitable for a user belonging to the specified country.

According to the technique in JP 6758582 B1 described above, it is possible to improve the accessibility of content desired by a visitor to a website. However, even in this case, it is not confirmed that the user who has visited such a site clicks a reservation button or the like of an accommodation facility set on the site, for example, and it is thought that generation of a web page intended to more reliably obtain conversion (hereinafter referred to as “CV”) has not yet been disclosed.

Furthermore, in addition to the display content of websites changing rapidly on a daily basis, there is a wide variety of requests from users, and users can access websites anytime and anywhere due to lifestyle changes in recent years. Due to such changes in the era, it is extremely difficult to construct a website (web page) or a landing page for reliably obtaining conversion from a user.

Furthermore, if all websites (web pages, especially landing pages or homepages) were to be prepared according to user conditions, the number of websites would be enormous, and it would require too much cost and time on the side which provides the website, which is not realistic.

In addition, in recent years, the method of accessing a website is not limited to the search engine described above. For example, a method of clicking a hyperlink (hereinafter referred to as a “link”) or the like described in message content distributed to a user by a company. Examples of such message content include a link shown in an advertisement, an article, or a post displayed on a social networking service (SNS) such as Facebook (registered trademark) or Twitter (registered trademark), and an advertisement displayed on (attached to) another website (e.g., social media such as a blog). A user who uses a medium other than a search engine has a wide range of interests and concerns. For example, even for the same product, service, or the like, there are some users who wish for information related to price and some users who wish for information related to function. The user determines the presence or absence of these pieces of information in a few seconds, and makes comparison with information posted on competing sites. For this reason, as a company that provides various kinds of information using a website, it is desired to provide more appropriate information to the user. However, if web pages are rearranged and produced one by one for users having various interests, concerns, and purposes as described above, there arises a problem that too much time and labor is needed for the user to search for target information and enormous cost is required.

Under such circumstances, an object of the present invention is to provide an information processing apparatus, an information processing system, and a program capable of distributing a web page according to user conditions while reducing time and cost in producing the web page.

To solve the above problem, an information processing apparatus according to an aspect of the present invention includes a distribution pattern generating section, a behavior pattern acquiring section, a clustering section, and a pattern distributing section. The distribution pattern generating section generates distribution patterns of a website including one or more materials. The behavior pattern acquiring section acquires user behavior patterns in the website through the website. The clustering section clusters two or more users as a group of users, the two or more users behaving in specific behavior patterns correlated with a target behavior pattern intended by a provider of the website among the behavior patterns acquired by the behavior pattern acquiring section, the specific behavior patterns being similar to each other. The pattern distributing section distributes a distribution pattern in which a reaction rate of the group of users clustered by the clustering section is relatively high among the distribution patterns generated by the distribution pattern generating section to a user terminal used by a user corresponding to the group of users.

According to the present invention, it is possible to distribute a web page according to user conditions while suppressing time and cost in creation of the web page.

### BRIEF DESCRIPTION OF THE DRAWINGS

FIG. 1 is a broad configuration diagram of an information processing system according to an embodiment of the present disclosure;

FIG. 2 is a hardware configuration diagram illustrating an example of a computer that implements functions of an information processing apparatus according to the embodiment of the present disclosure;

FIG. 3 is a conceptual diagram of information processing according to the embodiment of the present disclosure;

FIG. 4 is a functional block diagram of the information processing apparatus according to the embodiment of the present disclosure;

FIG. 5 is a schematic diagram illustrating an example of a distribution pattern generated by a distribution pattern generating section of the information processing apparatus according to the embodiment of the present disclosure;

FIG. 6 is a diagram illustrating a specific example of distribution pattern generation processing performed by the distribution pattern generating section of the information processing apparatus according to the embodiment of the present disclosure;

FIG. 7 is a flowchart depicting a flow of information processing according to the embodiment of the present disclosure;

FIG. 8 is a functional block diagram illustrating the information processing apparatus according to the embodiment of the present disclosure;

FIG. 9A is a schematic diagram illustrating a specific example of display order change processing performed by the information processing apparatus according to the embodiment of the present disclosure;

FIG. 9B is a schematic diagram illustrating a specific example of display order change processing performed by the information processing apparatus according to the embodiment of the present disclosure; and

FIG. 9C is a schematic diagram illustrating a specific example of display order change processing performed by the information processing apparatus according to the embodiment of the present disclosure.

### DETAILED DESCRIPTION

The following describes an embodiment for implementing the present invention in detail with reference to the accompanying drawings. Note that the present invention is not limited to the form described below, and various modifications can be made without departing from the technical concept.

FIG. 1 is a broad configuration diagram of an information processing system 1 in which an information processing apparatus 10 and a user terminal 20 are connected to each other through a network 50 according to the embodiment (referred to in the following as “the present embodiment”) of the present disclosure. Of these, the information processing apparatus 10 will be described later. Note that the configuration of the information processing system 1 illustrated in FIG. 1 is an example, and the configuration of the information processing system of the present invention is not limited to the configuration illustrated in FIG. 1.

Examples of the user terminal 20 include an information processing terminal such as a personal computer (referred to in the following as a “PC”) or a smartphone. Note that although FIG. 1 illustrates a PC as the user terminal 20, this is an example, and it need not be stated that the user terminal 20 is not limited to a PC. The user terminal 20 may include elements such as a controller, storage, a communication section, a display section, an input section, and a power supply. In a case where the user terminal 20 is an information processing terminal such as a smartphone or a tablet PC, the user terminal 20 may include constituent elements such as an imaging section, a voice input/output section, and a biometric authentication device in addition to the above.

The communication section (reception section) of the user terminal 20 receives a distribution pattern (described later) distributed from the information processing apparatus 10 through the network 50. The received distribution pattern (web page) is displayed through the display section of the user terminal 20. The controller of the user terminal 20 functions as a behavior information acquiring section, and the controller acquires behavior information of a user through a website (web page (distribution pattern)). The acquired behavior information may be transmitted to the information processing apparatus 10 through the network 50 by the communication section (transmission section).

The network 50 is an information communication network such as the Internet, a wide area network (WAN), or a local area network (LAN). The information processing apparatus 10 and the user terminal 20 may be connected to each other through the network 50. Note that the network 50 may be either a wired network or a wireless network.

[Hardware Configuration]

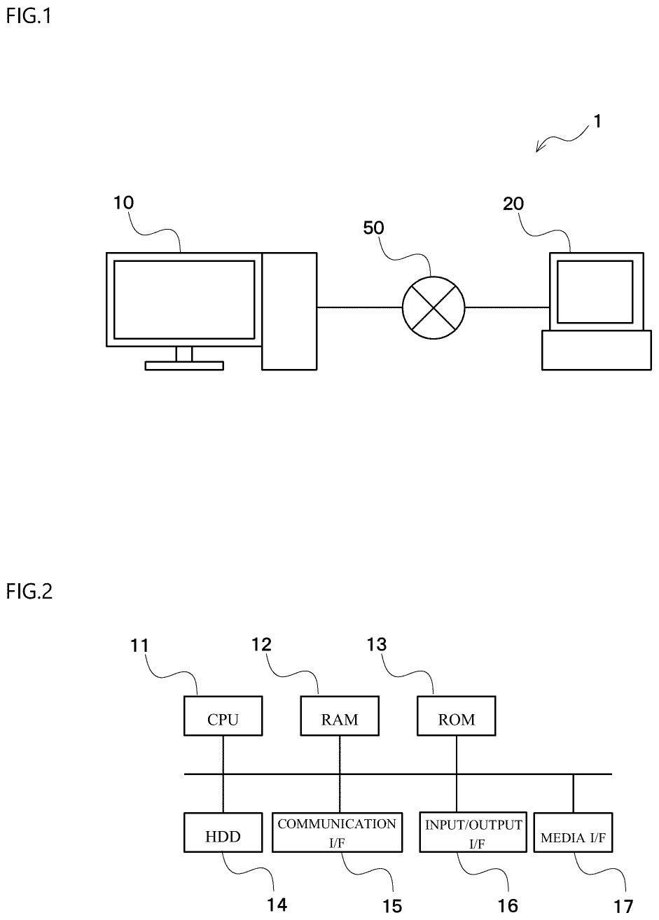

FIG. 2 is a hardware configuration diagram illustrating an example of a computer that implements functions of the information processing apparatus 10 according to the present embodiment. The information processing apparatus 10 according to the present embodiment is realized by, for example, a computer with a configuration as illustrated in FIG. 2. The computer according to the information processing apparatus 10 includes a central processing unit (CPU) 11, random-access memory (RAM) 12, read-only memory (ROM) 13, a hard disk drive (HDD) 14, a communication interface 15, an input/output interface 16, and a media interface 17.

The CPU 11 operates based on a program stored in the ROM 13 or the HDD 14, and controls each section. The ROM 13 stores items such as a boot program executed by the CPU 11 when the computer of the information processing apparatus 10 is activated and a program that depends on the hardware of a computer of the information processing apparatus 10.

The HDD 14 stores items such as a program executed by the CPU 11 and data used by the program. The communication interface 15 receives data from another device through a network, transmits the data to the CPU 11, and transmits data generated by the CPU 11 to another device through the network.

The CPU 11 controls an output device such as a display or a printer and an input device such as a keyboard or a mouse through the input/output interface 16. The CPU 11 acquires data from the input device through the input/output interface 16. In addition, the CPU 11 outputs generated data to the output device through the input/output interface 16.

The media interface 17 reads a program or data stored in a predetermined recording medium and provides the program or data to the CPU 11 through the RAM 12. The CPU 11 loads the program from the recording medium into the RAM 12 through the media interface 17, and executes the loaded program. Examples of the recording medium include an optical recording medium such as a digital versatile disk (DVD) or a phase change rewritable disk (PD), a magneto-optical recording medium such as a magneto optical disk (MO), a tape medium, a magnetic recording medium, and semiconductor memory.

For example, in a case of functioning as the information processing apparatus 10 according to the present embodiment, the CPU 11 of the computer realizes the function of each section (refer to FIG. 4) of the information processing apparatus 10 by executing a program loaded in the RAM 12. In addition, the HDD 14 stores various data handled by the CPU 11 (refer to FIG. 2) as a controller. The CPU 11 of the computer described above reads out and executes these programs from a recording medium 70, but as another example, these programs may be acquired from another device via a network.

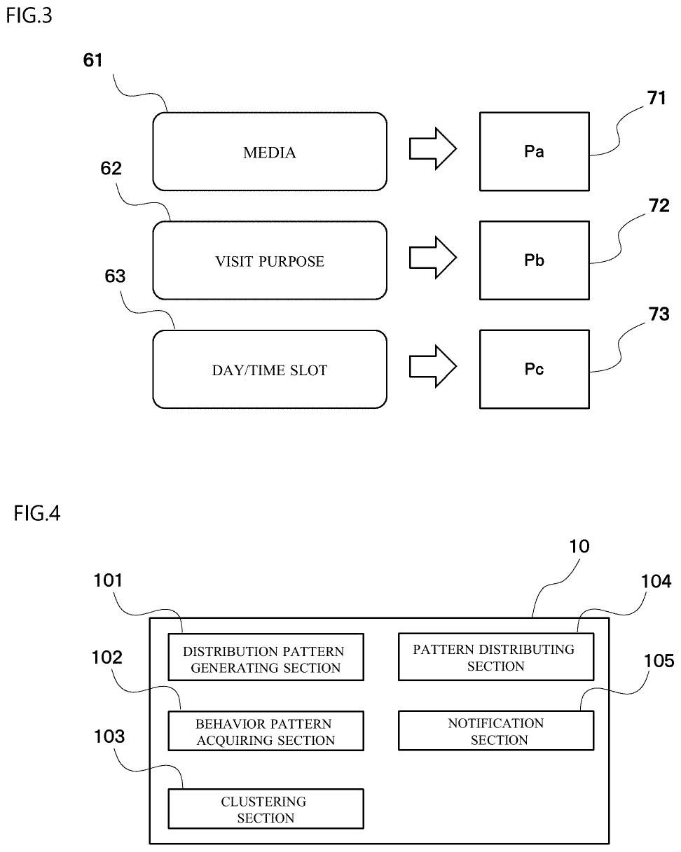

FIG. 3 is a conceptual diagram of information processing according to the present embodiment. Media 61, a visit purpose 62, and a day/time slot 63 are an example indicating under what kind of conditions a user who views a predetermined website has viewed the website. The media 61 indicates an inflow path of the user who visits the website, and examples of the inflow path include a search engine such as Yahoo (registered trademark) or Google (registered trademark). The visit purpose 62 indicates a purpose of the user who visits the website, and examples thereof include “curious”, “interested”, and “immediately purchasing”. The day/time slot 63 is time information indicating when the user visits the website.

Pa 71, Pb 72, and Pc 73 are examples of distribution patterns generated by a distribution pattern generating section 101 to be described later. Note that a “distribution pattern” according to the present embodiment is the display pattern of a web page (including a landing page (referred to in the following as an “LP”)) included in a website displayed through the display section of the user terminal 20 when the web page is distributed to the user terminal 20. Although details will be described later, the distribution pattern of the web page may include materials constituting the web page (hereinafter referred to as “constituent materials”) and positions in the web page at which those constituent materials are allocated (arrangement of constituent materials). Examples of the constituent materials include a title indicating the origin of the web page, a slogan that stimulates user appeal, an image such as an illustration or a photograph, and a user interface such as a button or an icon selectable by the user. Each of Pa 71, Pb 72, and Pc 73 includes one or more different elements among the above elements, and each is set as a mutually different distribution pattern.

The information processing according to the present embodiment relates to a technique of distributing an optimum distribution pattern according to the conditions of a user who views the website. That is, to describe FIG. 3 as an example, Pa 71, which is an optimum distribution pattern, may be distributed to the user who visits the website according to the media 61 (inflow route) of the user. Further, Pb 72, which is an optimum distribution pattern, may be distributed to the user who visits the website according to the visit purpose 62 of the user. In addition, Pc 73, which is an optimum distribution pattern, may be distributed to the user who visits the website according to the day/time slot 63 of the user. As described above, when the optimum distribution pattern (web page or LP) is distributed according to the conditions of the user who views the website, and the dwell time of the user in the web page becomes relatively long, it is thought that conversion is easily obtained from the user. The following describes details of the information processing according to the present embodiment.

FIG. 4 is a functional block diagram of the information processing apparatus 10 according to the embodiment of the present disclosure. The information processing apparatus 10 according to the present embodiment includes the distribution pattern generating section 101, a behavior pattern acquiring section 102, a clustering section 103, a pattern distributing section 104, and a notification section 105.

The distribution pattern generating section 101 generates a distribution pattern of a website including one or more materials (constituent materials). A “material” refers to a material set in advance as content of each piece of information included in web pages forming a website. Examples of the information included in a web page include information related to color information and shapes of Cascading Style Sheets (CSS) objects such as text information, image information, and buttons, information related to display positions of the foregoing, information related to movement of the foregoing, information related to sound, and information related to display on other websites. Text information includes information related to text content, information related to character color, font information, information related to character size, and information related to borders, for example. Furthermore, image information includes information related to image content, information related to image type, information related to still images or moving images, and information related to image size, for example.

The distribution pattern generating section 101 generates a distribution pattern to be displayed to the user by combining materials corresponding to one or more pieces of information among the information described above. In this case, the materials corresponding to the above information can be extracted from the material set in advance. Examples of the material corresponding to text information include appeal texts related to “price appeal”, “benefit appeal”, and “trust appeal”. Furthermore, examples of the material corresponding to image information include visual information such as “man image”, “woman image”, and “product image”. In addition, examples of the material corresponding to a button include “for details”, “inquiry”, and “request for information materials”.

The distribution pattern generating section 101 can generate distribution patterns formed by combining the above materials using an experimental design method which is an applied method of statistics. Details of the procedure for generating distribution patterns using the experimental design method will be described later.

The behavior pattern acquiring section 102 acquires a user behavior pattern in the website through the website. A “behavior pattern” according to the present embodiment refers to classified user behavior information in the website. Examples of user “behavior information” in the website include a screen scroll operation, a click operation, an operation related to display of an input form, and an operation of moving a mouse cursor to the form. The user behavior information in the website may be acquired by a JavaScript tag embedded in the website, for example.

The behavior pattern acquiring section 102 acquires items such as web page information or web page header information that may be acquired via the website, clock information or position information that may be acquired through the user terminal when a user views a web page, a search query, and information related to customer attributes provided from the owner of another website together with the behavior information. Note that examples of the web page information include a Uniform Resource Locator (URL), URL parameters, and HyperText Markup Language (HTML) structure information. Examples of the header information include a user agent, a cookie, an Internet Protocol (IP) address, and a referrer. Furthermore, the customer attributes may be acquired by a customer relationship management (CRM) system, for example.

The behavior pattern acquiring section 102 acquires behavior patterns in which user behavior information is classified in consideration of information such as the web page information, the header information, the clock information, and the position information described above. The behavior pattern acquiring section 102 acquires, as a specific behavior pattern, a behavior pattern that induces conversion (purchase, inquiry, request for information materials, questions, etc.) among the acquired behavior patterns. Examples of the specific behavior pattern include “dwell time in a specific web page (or LP) is long”, “a scrolling operation is performed many times in a specific web page (or LP)”, and “a button for shifting to a form input screen is pressed”. In the present embodiment, a behavior pattern related to conversion is referred to as a “target behavior pattern”.

The clustering section 103 clusters two or more users as a group of users (similar cluster), the two or more users behaving in specific behavior patterns correlated with a target behavior pattern intended by the provider of the website among the behavior patterns acquired by the behavior pattern acquiring section 102, the specific behavior patterns being similar to each other. For example, a k-means method according to machine learning (unsupervised learning) or the like can be suitably used as a clustering method of the clustering section 103. A group of users clustered by the clustering section 103 and users corresponding to the group of users are assigned character strings including numbers, letters, symbols, and the like, for example. It is possible to determine similar clusters to which each user corresponds using the assigned character strings. Note that the clustering method is not limited to the k-means method described above, and other clustering methods such as the Ward method may be used.

The clustering section 103 may cluster two or more users with specific behavior patterns as a group of users based on clock information (a hardware clock, a system clock, etc.) of a terminal used by a user when accessing the website.

The clustering section 103 may also cluster two or more users with specific behavior patterns as a group of users based on referrer information that may be acquired through the website. “Referrer information” refers to a website that is a reference source of the website, and examples thereof include a URL of Facebook (registered trademark).

The clustering section 103 may further cluster two or more users with specific behavior patterns as a group of users based on a search query that may be acquired through the website. “Search query” refers to a search term input by the user to arrive at the website. The “referrer information”, “search query”, or the like may be acquired from items such as an access log or a URL parameter recorded in a web server.

Regardless of the above, the clustering section 103 may cluster two or more users with specific behavior patterns as a group of users based on any two or more pieces of information from the clock information, the referrer information, and the search query, or user behavior information, information related to a reaction to a prepared distribution pattern, information indicating the degree of interest of a user using a questionnaire function, or the like. Examples of user behavior information include information related to dwell time for each display position indicating content in a web page that a user has indicated interest in, information related to a scroll operation, and information related to a position where a user withdraws.

When clustering as a group of users (learning similar clusters) as described above, the clustering section 103 considers a reaction of a user to each of a plurality of distribution patterns randomly distributed by the pattern distributing section 104 described later. Reactions of each of a plurality of users are collected, and a ratio of a reaction (specific behavior) that induces conversion among the plurality of collected reactions is set as a reaction rate. The clustering section 103 performs the above clustering based on the level of the reaction rate.

In the above clustering by the clustering section 103, for example, a default learning period of 3 months may be set, and after 3 months, similar clusters may be updated every month according to a learning result. In this case, a default learning period and an update frequency of a similar cluster may be appropriately set.

The pattern distributing section 104 distributes a distribution pattern having a relatively high reaction rate by a group of users clustered by the clustering section 103 among a plurality of distribution patterns generated by the distribution pattern generating section 101 to user terminals used by the users corresponding to the group of users. As a result, a web page (distribution pattern) may be distributed according to user conditions.

The pattern distributing section 104 can perform equal distribution in which all of the distribution patterns generated by the distribution pattern generating section 101 are distributed to the users corresponding to the group of users at equal ratios. As a result, for example, both a distribution pattern to be distributed to a user for the first time and a distribution pattern with a relatively small number of views are distributed. Therefore, omission of a user behavior pattern through these distribution patterns can be prevented (opportunity loss can be reduced), and according to the above, it is possible to cope with a change of trend in the distribution patterns.

The pattern distributing section 104 can perform optimized distribution in which distribution is performed such that a distribution ratio of a distribution pattern in which a reaction rate by the group of users is relatively high is larger than a distribution ratio of a distribution pattern in which a reaction rate by the group of users is relatively low among the plurality of distribution patterns generated by the distribution pattern generating section 101.

The distribution ratios of the equal distribution and the optimized distribution can be appropriately set. In this case, for the purpose of increasing the distribution ratio of the optimized distribution, the distribution ratio may be set to be automatically controllable such that the distribution ratio of the equal distribution reaches a specified minimum distribution amount (e.g., 1,000 times).

The notification section 105 can notify of a processing result, a warning, or the like by the information processing apparatus 10 through a desired output device (e.g., the display section or the voice output section) included in the information processing apparatus 10. As a result, an operator who uses the information processing apparatus 10 can grasp a processing result obtained by processing of the information processing apparatus 10. In addition, when a warning is notified of in a case such as where the processing result by the information processing apparatus 10 is poor, the operator can quickly take measures against the poor processing result.

In the information processing apparatus 10 of the present embodiment, a difference between the result (the number of conversions (CVs)) obtained by the above-described optimized distribution and the result (the number of conversions (CVs)) obtained by the equal distribution is aggregated. The notification section 105 can notify (e.g., display to) the operator of the information processing apparatus 10 of the difference. “Optimized distribution (also referred to as inclined distribution)” refers to distribution (distribution on a slope) in which, when 10 distribution patterns are prepared, each one is distributed uniformly by 10%, or the distribution ratio of a specific one is set to 50% and the distribution ratio of the remaining 9 is set to 5%. By contrast, “equal distribution” means that all the distribution patterns generated by the distribution pattern generating section 101 are distributed in rotation at literally equal ratios. The notification section 105 displays the difference through a monitor or the like of the information processing apparatus 10, so that the operator can visually recognize the difference as a lift effect.

In the present embodiment, similar clusters may be clustered by the clustering section 103 with attributes that are easy for people to interpret, such as “a user who flows in via Facebook (registered trademark) on Saturday morning” and “a user who flows in via Yahoo (registered trademark) in the morning”, for example. Then, factors by which the similar clusters clustered by the clustering section 103 are sorted can be recorded in the form of a report, for example. The notification section 105 can also notify a marketer of the report related to the achievement in similar cluster units. As a result, it is possible to grasp what kind of target the similar cluster corresponding to the desired distribution pattern is, and thus, it is possible to provide an opportunity for marketers to conceive new distribution patterns. Furthermore, according to the report, it is possible to grasp how much achievement improvement can be expected with respect to a population parameter of users who view the distribution pattern in a more optimized distribution pattern (web page).

<<Distribution Pattern Generation>>

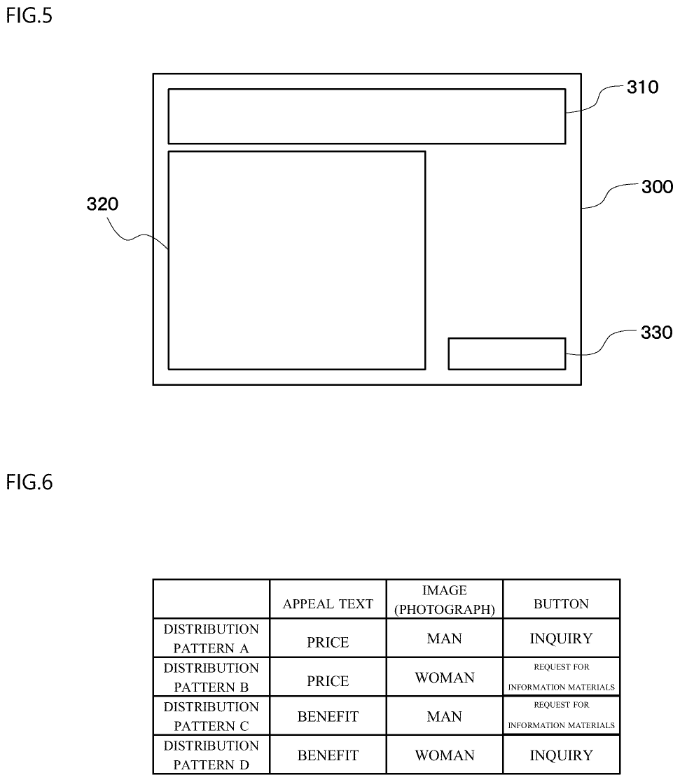

FIG. 5 is a schematic diagram illustrating an example of a distribution pattern generated by the distribution pattern generating section 101 of the information processing apparatus according to the embodiment of the present disclosure. FIG. 6 is a diagram illustrating a specific example of distribution pattern generation processing performed by the distribution pattern generating section 101 of the information processing apparatus according to the embodiment of the present disclosure.

In the distribution pattern 300 illustrated in FIG. 5, an appeal text 310 related to a slogan which stimulates user appeal as described above, a desired image (e.g., an image related to a man or an image related to a woman) 320, and a button 330 which is displayed so as to be selectable by the user are arranged. The arrangement of the appeal text 310, the image 320, and the button 330 in the distribution pattern 300 is an example and not a limitation, and various distribution patterns (e.g., including a combination of constituent materials such as an image and a text or information defining arrangement of the constituent materials) may be set by the distribution pattern generating section 101.

An example of a distribution pattern generation method using the experimental design method of the distribution pattern generating section 101 will be described with reference to FIG. 6 using the distribution pattern 300 illustrated in FIG. 5 as an example. FIG. 6 is illustrated as a table of 4 rows and 3 columns. “Distribution pattern A”, “distribution pattern B”, “distribution pattern C”, and “distribution pattern D” are shown in the first to fourth rows of the leftmost column, and materials of “appeal text”, “image (photograph)”, and “button” are shown in the first to third columns of the uppermost row (refer to FIG. 6). In addition, “price”, “price”, “benefit”, and “benefit” are set in the first to fourth lines of “appeal text” in the first column (refer to FIG. 6). In “image (photograph)” in the second column, “man”, “woman”, “man”, and “woman” are set. In “button” in the third column, “inquiry”, “request for information materials”, “request for information materials”, and “inquiry” are set (refer to FIG. 6). FIG. 6 is illustrated as an example of an orthogonal array table of “L4 (2³)” according to the experimental design method.

In a case where two materials are set at three locations (appeal text, image, and button), there are 2³=8 normal combinations, but according to the orthogonal array table (L4) illustrated in FIG. 6, there are 4 normal combinations. According to the experimental design method, it is possible to obtain substantially the same verification result as in the case of 8 distribution patterns with the 4 distribution patterns and without generating all 8 distribution patterns.

<<Distribution Pattern Generation Processing>>

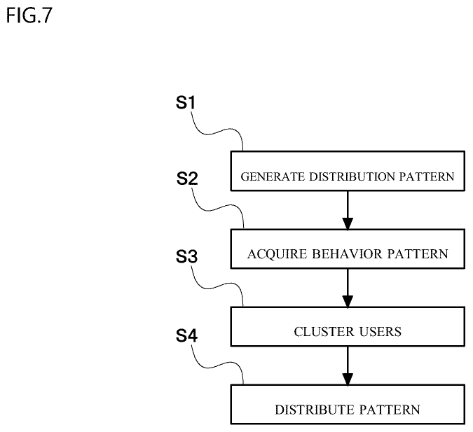

FIG. 7 is a flowchart depicting a flow of each item of information processing according to the embodiment of the present disclosure. The following information processing according to the present embodiment may be specifically realized by the above-described information processing apparatus 10 (hardware). First, the information processing apparatus 10 generates a distribution pattern of a website including one or more materials (Step S1).

<<Behavior Pattern Acquisition Processing>>

Next, the information processing apparatus 10 acquires a user behavior pattern in the website (including existing web pages in addition to the generated distribution patterns described above) through the website (Step S2).

<<Clustering Processing>>

Thereafter, the information processing apparatus 10 clusters two or more users as a group of users, the two or more users behaving in specific behavior patterns correlated with a target behavior pattern intended by the provider of the website among the behavior patterns acquired in Step S2, the specific behavior patterns being similar to each other (Step S3).

<<Pattern Distribution Processing>>

Thereafter, the information processing apparatus 10 distributes a distribution pattern with a relatively high reaction rate of the group of users clustered in Step S3 among the distribution patterns generated in Step S1 to user terminals used by the users corresponding to the group of users (Step S4).

According to the above information processing in the present embodiment, it is possible to distribute a web page according to user conditions while suppressing time (e.g., marketer working hours) and cost in the production of a website.

The embodiment described above is meant to facilitate understanding of the present invention, and is not meant to limit the present invention. Therefore, each element disclosed in the above embodiment is intended to include all design changes and equivalents falling within the technical scope of the present invention. According to the present embodiment, a distribution pattern (web page or landing page) is distributed according to user conditions. As a result, engagement of a user who views a web page (distribution pattern) can be increased (i.e., the probability of conversion can be increased), and thus conversion can be easily obtained from the user. By contrast, from the viewpoint of more reliably obtaining conversion from the user, it is important to prevent the user from overlooking information required by the user in a desired website. Therefore, in the web page or the landing page, it is also important to construct a means for extending the time for connecting to the information requested by the user, shortening the timing for connecting to the information after visiting the website, or the like. As such, an additional configuration of the information processing apparatus 10 according to the present embodiment in which these means may be implemented will be described below.

FIG. 8 is a functional block diagram of an information processing apparatus according to an embodiment of the present disclosure. The information processing apparatus 10 illustrated in FIG. 8 further includes an arrangement changing section 106 in addition to each processing section illustrated in FIG. 4. The arrangement changing section 106 can change the arrangement of materials in a distribution pattern including two or more materials according to the degree of user interest in the materials. Each material is the above-described constituent material, and the “arrangement” is positions to which the materials are allocated in the distribution pattern. For example, in a case where the distribution pattern is an LP in which content (e.g., display of an image) as the materials is arranged in columns, the display order of the pieces of content is included in the concept of “arrangement” as described above. The “degree of user interest” means the degree of user interest for each piece of content constituting the LP, for example, in a case where the distribution pattern is the above LP.

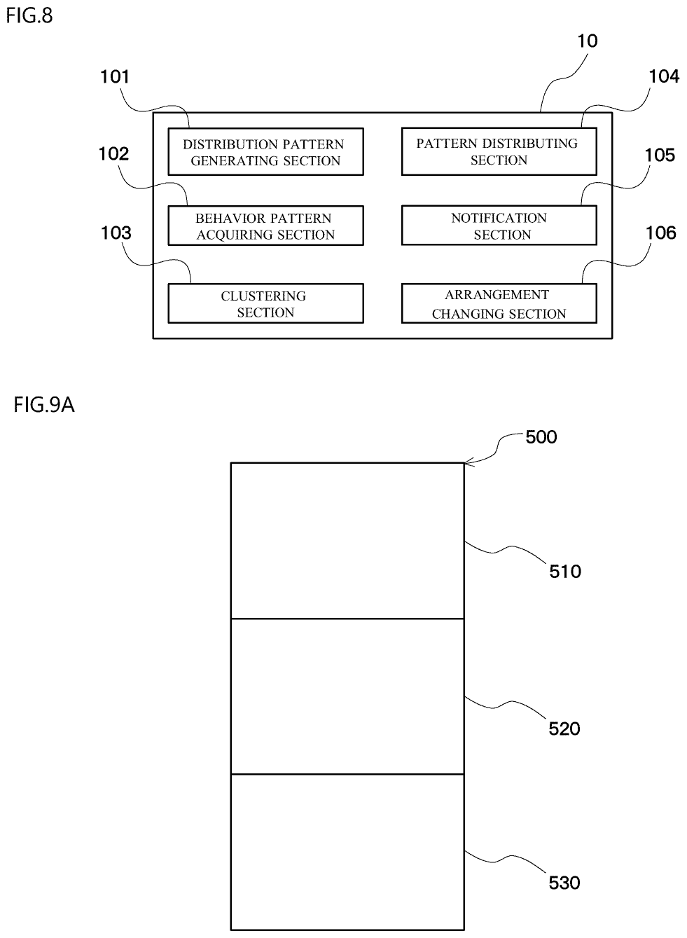

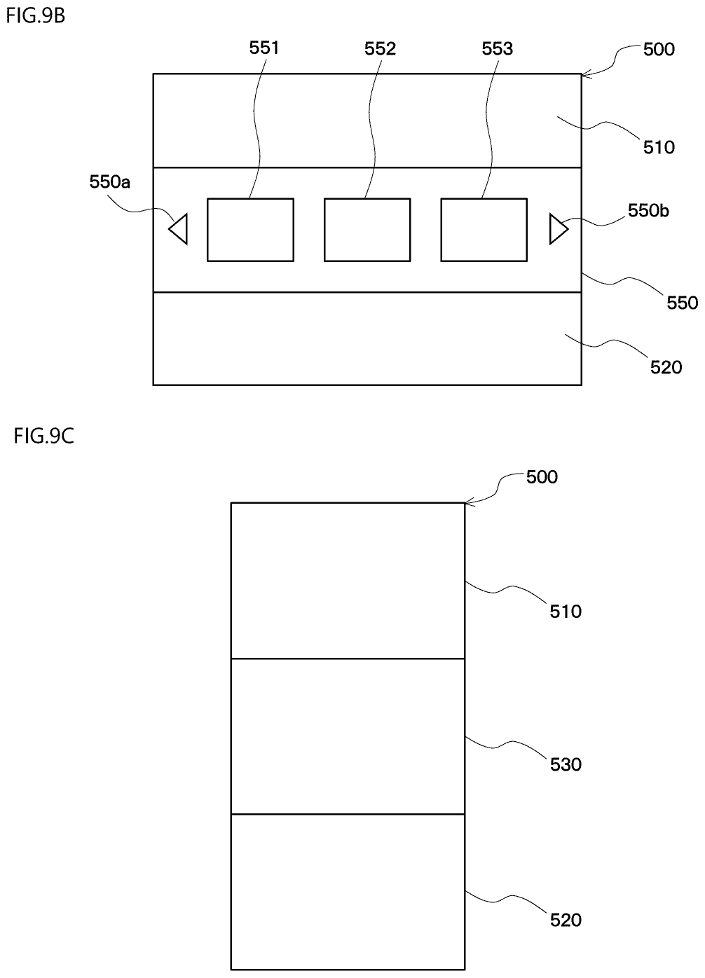

FIGS. 9A, 9B, and 9C are schematic diagrams illustrating a specific example of display order change processing performed by the information processing apparatus according to the embodiment of the present disclosure. FIG. 9A is a diagram illustrating a display screen example (distribution pattern) of a landing page (LP) 500 on which a plurality of pieces of content is displayed in order from top to bottom by scroll operation, for example. In the LP 500 of the present drawings, content (section) 510, content 520 to be arranged next to the content 510, and content 530 to be arranged next to the content 520 are displayed (refer to FIG. 9A).

According to the display example of FIG. 9A, in a case where the content 510 is content related to “product features” and the content 520 is content related to “customer's voice”, it is considered possible that the content 520 is uninteresting content depending on the user viewing the LP 500. In such a case, it is assumed that the user who saw the content 510 (product features) may withdraw from the LP 500 when the content 520 (customer's voice) is displayed. Note that, in the following description, the content 530 is assumed to be content related to a “reason why (a product) is selected”.

Therefore, the inventor of the present invention has found that displaying a content menu 550 within content or between items of content (refer to FIG. 9B) is useful as a means of reducing the above possibility. In the content menu 550, selection buttons (thumbnail displays) 551, 552, and 553, which are displayed as simple displays of the respective contents included in the LP 500 so as to be selectable by the user, are arranged in a row. Furthermore, a scroll button 550a for moving the selection buttons from left to right is displayed on the left side of the selection button 551, and a scroll button 550b for moving the selection buttons from right to left is displayed on the right side of the selection button 553.

In the following description, the content menu 550 will be described as a questionnaire menu for investigating which content the user is interested in among the pieces of content included in the LP 500. Furthermore, it is assumed that an image related to “product characteristics” is allocated to the selection button 551, an image related to “customer's voice” is allocated to the selection button 552, and an image related to “reason for selecting (product)” is allocated to the selection button 553. Note that, for example, guidance text such as “What would you like to know next?” may be displayed at an arbitrary position in the content menu 550. As a result, it is possible to prompt (guide) the user to perform the next action (e.g., clicking the selection buttons). Furthermore, the content menu 550 in this case may function as a questionnaire menu for investigating user interest. When the user clicks the selection buttons in the content menu 550 functioning as a questionnaire menu, the information processing apparatus 10 aggregates the number of clicks (behavior information), and the clustering section 103 can perform clustering as a similar cluster in consideration of which menu (content) the user is interested in based on the aggregation result.

When the selection buttons are selected by the user through an operation such as mouse click, transition to content corresponding to a respective selection button may be performed. Here, it is assumed that the selection button 551 corresponds to the content 510, the selection button 552 corresponds to the content 520, and the selection button 553 corresponds to the content 530. In LP 500, when the user attempts to scroll the screen from the content 510 to the content 520 through a scroll operation, the content menu 550 is assumed to be displayed (in any one of the following display modes). When clicking any one of the selection buttons 551 to 553 in the displayed content menu 550, the user may be forced to scroll to one of the corresponding content 510 to 530. As a result, the user can view content of interest. As described above, for example, it is assumed that a user who is not interested in the content 520 wants to view the content 530 corresponding to the selection button 553 from the image related to “reason for selecting (product)” set to the selection button 553 of the content menu 550. In this case, when the user clicks the selection button 553, screen scroll processing is performed on the content 530. As a result, the user can view the content 530 which is more interesting than the content 520.

As described above, it is possible to display content that the user wishes to view, and thus it is possible to reduce the rate of user withdrawal from the LP 500. Note that, by implementing shading display processing or the like with a gray transmission color or the like on the selection button 551 corresponding to the previously displayed content 510, it may be possible to clearly indicate to the user that the content 510 has been displayed.

Also note that the display form of the content menu 550 may be an “insertion mode” in which the content menu 550 is displayed so as to be inserted between the pieces of content as illustrated in FIG. 9B when screen scrolling is performed, or may be an “overlay mode” in which the content menu 550 is displayed with a background of a transparent color in an overlay manner on each piece of content, for example.

The display order of the selection buttons in the content menu 550 may be appropriately changed on each user's side. In addition, display and non-display of the content menu 550 itself may be selected in settings.

The display order of content suitable for enhancing user engagement can be constructed in advance by acquiring the button click operation (behavior information) of a user in the content menu 550 through the behavior pattern acquiring section and verifying the acquired behavior pattern. In the above example, when a user who is interested not in the content 520 but in the content 530 has clicked the selection button 553 of the content menu 550, the behavior pattern acquiring section 102 acquires the user behavior information according to the click. Based on the above user behavior information acquired by the behavior pattern acquiring section 102, the arrangement changing section 106 changes the display order of the pieces of content so that the content 530 is displayed before the content 520 (refer to FIG. 9C). As a result, it is thought that the rate of user withdrawal from the LP 500 can be reduced, and the user engagement can be increased.

As a result of the display order (arrangement) change processing by the arrangement changing section 106, processing information related to the changed display order is stored as a report for each similar cluster and is notified of by the notification section 105, so that a marketer can grasp what kind of display order (arrangement) is optimal for what kind of user. This allows the marketer to construct LPs (web pages) in a more optimized display order (arrangement).

What is claimed is:

1. An information processing apparatus comprising:
a distribution pattern generating section configured to generate distribution patterns of a website including one or more materials;
a behavior pattern acquiring section configured to acquire user behavior patterns in the website through the website;
a clustering section configured to cluster two or more users as a group of users, the two or more users behaving in specific behavior patterns correlated with a target behavior pattern intended by a provider of the website among the behavior patterns acquired by the behavior pattern acquiring section, the specific behavior patterns being similar to each other; and
a pattern distributing section configured to distribute a distribution pattern in which a reaction rate of the group of users clustered by the clustering section is relatively high among the distribution patterns generated by the distribution pattern generating section to a user terminal used by a user corresponding to the group of users.

2. The information processing apparatus according to claim 1, wherein
the clustering section clusters the two or more users having the specific behavior patterns as the group of users based on clock information of a terminal used by a user when accessing the website.

3. The information processing apparatus according to claim 1, wherein
the clustering section clusters the two or more users having the specific behavior patterns as the group of users based on referrer information acquired through the website.

4. The information processing apparatus according to claim 1, wherein
the clustering section clusters the two or more users having the specific behavior patterns as the group of users based on a search query acquired through the website.

5. The information processing apparatus according to claim 1, wherein
the pattern distributing section performs equal distribution in which all of the distribution patterns generated by the distribution pattern generating section are distributed to the users corresponding to the group of users at an equal ratio.

6. The information processing apparatus according to claim 1, wherein
the pattern distributing section performs optimized distribution in which distribution is performed such that a distribution ratio of the distribution pattern in which the reaction rate by the group of users is relatively high is larger than a distribution ratio of a distribution pattern in which the reaction rate by the group of users is relatively low among the distribution patterns generated by the distribution pattern generating section.

7. The information processing apparatus according to claim 6, further comprising
a notification section configured to notify of a difference between a result obtained through the optimized distribution and a result obtained through the equal distribution.

8. The information processing apparatus according to claim 1, further comprising
an arrangement changing section configured to change an arrangement of the materials in the distribution pattern including two or more of the materials according to a degree of user interest in each of the materials.

9. An information processing system comprising:
an information processing apparatus; and
a user terminal, wherein
the information processing apparatus includes:
a distribution pattern generating section which generates distribution patterns of a website including one or more materials;
a behavior pattern acquiring section which acquires user behavior patterns in the website through the website;
a clustering section which clusters two or more users as a group of users, the two or more users behaving in specific behavior patterns correlated with a target behavior pattern intended by a provider of the website among the behavior patterns acquired by the behavior pattern acquiring section, the specific behavior patterns being similar to each other; and
a pattern distributing section which distributes a distribution pattern in which a reaction rate of the group of users clustered by the clustering section is relatively high among the distribution patterns generated by the distribution pattern generating section to the user terminal used by a user corresponding to the group of users, and
the user terminal includes:
a reception section which receives the distribution patterns distributed by the pattern distributing section;
a display section which displays the distribution patterns received by the reception section;
a behavior information acquiring section which acquires user behavior information through the distribution patterns displayed by the display section; and
a transmission section which transmits the behavior information acquired by the behavior information acquiring section to the information processing apparatus.

10. A program which causes a computer to implement:
distribution pattern generation processing to generate distribution patterns of a website including one or more materials;
behavior pattern acquisition processing to acquire user behavior patterns in the website through the website;
clustering processing to cluster two or more users as a group of users, the two or more users behaving in specific behavior patterns correlated with a target behavior pattern intended by a provider of the website among the behavior patterns acquired in the behavior pattern acquisition processing, the specific behavior patterns being similar to each other; and
pattern distribution processing to distribute a distribution pattern in which a reaction rate of the group of users clustered in the clustering processing is relatively high among the distribution patterns generated in the distribution pattern generation processing to a user terminal used by a user corresponding to the group of users.
